(19) United States
(12) Patent Application Publication
(10) Pub. No.: US 2012/0204843 A1
(43) Pub. Date: Aug. 16, 2012

(54) FUEL HEATER SET WITH FUSE EFFECT

(75) Inventors: Eduardo Dos Santos COSTA, Campinas-SP (BR); Marcelo Renato CAVAGLIERI, Indaiatuba-SP (BR); Guilherme Henrique Mayer ALEGRE, Jundiai-SP (BR); Cleber De Jesus LOPES, Indaiatuba-SP (BR); Marco Aurelio DUDUCH, Campinas-SP (BR); Fernando Luiz WINDLIN, Jundiai-SP (BR)

(73) Assignee: Magneti Marelli Sistemas Automotivos Indústria e Comércio Ltda, Hortolandia (SP) (BR)

(21) Appl. No.: 13/371,206

(22) Filed: Feb. 10, 2012

(30) Foreign Application Priority Data
Feb. 11, 2011 (BR) PI 1100311-1

(51) Int. Cl. F02M 31/125

(52) U.S. Cl. 123/549

(57) ABSTRACT

A device is provided to heat fuel with a safety feature (fuse effect). The heating device can be operated with ethanol, gasoline or a mixture of ethanol and gasoline. The heating device is an integrant part of the electronic injection system of internal combustion engines. The heating device is assembled inside the fuel rail and serves to increase fuel temperature before, during and after ignition at temperatures specified by the engine calibration strategy.

### RELATED APPLICATION

The present application hereby claims priority under 35 U.S.C. Section 119 to Brazilian Patent application number PI 1100311-1, filed Feb. 11, 2011, the entire contents of which are hereby incorporated by reference.

### FIELD OF INVENTION

The present invention discloses a device to heat fuel with a safety feature known as fuse effect. Said device operates on ethanol, gasoline or a mixture of ethanol and gasoline, being part of the electronic injection system of internal combustion engines—ICE.

The device is assembled inside the fuel rail and its function is to increase fuel temperature before, during and after ignition at low temperatures

### BACKGROUND

With advancements in Flex Fuel technology, the use of ethanol for ICE has increased in the past few years. This means lower cost in comparison with the use of gasoline or diesel fuels and also a benefit to the environment when the results of discharge gas emissions are analyzed. However, automotive engines operating with ethanol have ignition difficulties when the temperature is below 15° C. due to the ethanol vaporization pressure be very low and its flash point be higher than operating with gasoline. For this reason, current systems have a secondary tank containing gasoline which is used to start engine when its temperature is below 15° C.

In Brazilian patent PI 0504015-9 by Márcio Turra de Ávila and Marcelo Valente Feitosa, the solution found for cold ignition was the use of an independent system, provided with a heating coil, and the use of an injector (or fuel injector, or atomizer) for the secondary fuel. With that solution, the number of fuel injectors to inject gasoline into the intake manifold or engine will always be a multiple of the number of fuel injectors used for ethanol injection. In this kind of solution, the problem is the high cost of the system due to the use of two fuel injectors, one for cold ignition of gasoline and another for the normal operation of the engine, for each engine cylinder.

Brazilian patent PI 0703443 by Ademar Rudge Filho discloses a solution using a system with a fuel rail to distribute fuel for cold ignition to the injector, wherein there is an exclusive injector for cold ignition for each engine cylinder. The great disadvantage of this system is the high cost due to the use of an additional injector for each engine cylinder solely dedicated to the cold ignition of the engine at low temperature.

Brazilian patent PI 0705422-0 by Gino Montanari et al discloses a tube device of heat diffusion passive regulation connected to one or more heating devices and inserted into a fuel supply primary rail in an ethanol cold start system.

Brazilian patent MU 8403382-7 by Eduardo Augusto de Campos discloses a controlled heating device for the body of the main fuel injector, reporting that it has great technical and functional advantages over conventional ignition systems with gasoline.

Brazilian patents PI 0403039-7 and PO40104172 by Eduardo Augusto de Campos disclose the whole strategy of the ethanol cold start system, reporting the concept of the utilization of a heating device for fluid fuel which is activated by a signal coming from a sensor installed on the vehicle door or another kind of signal. The device object of this patent application is an integrant part of the invention strategy disclosed. The author, Eduardo Augusto de Campos, also discloses in Brazilian patents PI0405182 and PI 0405181, possible configurations to heat the fluid fuel of the cold start system.

Brazilian patent PI 0805484-3 by Akio Omori et al discloses the way of axial installation of heating devices in a primary fuel supply rail of the no-return kind, which increases the homogeneity of the heat flow in a cold start system with ethanol ECS®. The device object of this patent application, is an integrant part of this invention disclosed.

The heating device assembled inside the fuel rail is designed to transform electric energy into thermal energy (Joule effect) transferring its heating potential to the fuel present inside the chamber to be later transported heated and to be sprayed to engine cylinders by fuel injectors.

U.S. Patent Application Publication No. 2009/0308362.A1 by Jens Schneider et al discloses a heater whose resistance element is in a powder composed of insulating and refractory material, which is inserted into a metal tube shaped to compress the powder on the resistance element. Other devices with similar functions have already been patented and manufactured by several corporations, both in Brazil and abroad, but they do not have the safety feature (fuse effect) required to guarantee the integrity of the system in case of control failure in the electronic control unit (ECU). Said function is even more important in applications where fuel rails are made of polymeric materials.

### SUMMARY

An objective of the fuel heater with fuse effect, of the present invention is to transform electric energy into thermal energy (Joule effect) transferring, as much as possible, its heating potential to the fuel present inside the chamber to be later transported heated and to be sprayed to engine cylinders by fuel injectors.

Another objective of such device, is directed to safety, by the introduction of a fragile resistance element designed to break, under critical operation conditions, in a time that can guarantee the integrity/leakproofness of the fuel rail made of plastic material.

A further objective of said device, is to reduce exhaust pollutant gas emissions by improving combustion efficiency in the engine, both at the time of ignition and also in the post-ignition period, when the cold fluid from the fuel tank would be in contact with the warming up engine.

A still further objective of said device, but no less important, is the fact that it has positive and negative terminals, to allow its use in applications where fuel rails are made of polymeric materials.

The fuel heater with fuse effect is assembled in the cold ignition system (CI) for ethanol, placed in axial direction, but not solely, inside the fuel rail set. The heating region is formed by a thin wall metal tube containing a heating device within it. Said element is covered by a mineral, such as magnesium oxide (MgO), compressed by the metal tube. Other embodiments with the same characteristics of MgO can also be used.

The heating device is also designed to have a characteristic curve of premature degradation in case of any failure in the control system, involving either the electronic control unit or the power module used for switching. The device at issue dissipates electric power P consuming an electric current I when submitted to electric voltage E. Variations of the physical quantities mentioned may occur due to changes in application, i.e., in the volume or geometry of the fuel rail and/or tolerances in manufacturing/industrialization processes.

After detecting the ignition intention of the driver, the electronic control unit starts to control the fuel heater with fuse effect by the power module according to the temperature of the engine cooling fluid, and using as a reference the ambient temperature determined by the Tmap sensor installed in the engine air intake system. The signal sent by the electronic control unit to the heating control at issue may be either continuous or discreet, and it may present a quadratic wave with duty cycle variations depending on the kind of cycle required or any other characteristic that may become necessary to optimize the performance and/or adequation to new project requirements.

### BRIEF DESCRIPTION OF THE DRAWINGS

The present invention will be better understood in the light of the attached figures, given as mere examples, but not limitative, wherein:

FIG. 1—schematically represents the conventional feeding system of gasoline for cold start, showing the reservoir (2), fuel pump for appropriate flow (5), feeding pipes (7), fuel dosage valve (6), mini fuel rail (3) for fuel distribution, calibrated inserts (4) and engine intake manifold (1);

FIG. 2—shows a transparent tridimensional view of the fuel rail set, where the elements of the present invention are shown, particularly the left fuel heater with fuse effect (1) and its other components;

FIG. 3—shows a tridimensional view of the fuel rail set that distributes and supplies fuel to the engine, including the left fuel heater with fuse effect (1) of the present invention;

FIG. 4—refers to the cross section view of the fuel heating set with fuse effect (1);

FIG. 5—refers to the tridimensional view of the fuel heating set with fuse effect of FIG. 4;

FIG. 6—refers to the view of the heating set with a solution of direct welding to the fuel rail;

FIG. 7—refers to the tridimensional view of a volume reducer existing in the fuel rail, which can be eliminated with the solution presented in FIG. 6;

FIG. 8—refers to the tridimensional view of the heater assembly lock spring in the fuel rail, which can be eliminated with the solution presented in FIG. 6;

FIG. 9—refers to the view of the external metal tube that compacts the insulating mineral MgO in its primitive production stage;

FIG. 10—refers to the view of the heating element designed to work as fuse effect and guarantee the integrity of the system;

FIG. 11—refers to the view of the main metal body of the set;

FIG. 12—refers to the view of the external metal tube that compacts the insulating mineral MgO;

FIG. 13—refers to the view of the metal rod that transmits the electric current to the heating element of FIG. 12;

FIG. 14—refers to the view of the assembly of the heating element designed to work as fuse effect (1) in the metal rod that transmits the electric current (2);

FIG. 15—refers to the cross section view of the assembly of the external metal tube (1) that compacts the insulating mineral MgO in the subset of FIG. 16 (1 and 2);

FIG. 16—refers to the cross section view of the compacted insulating mineral MgO (3) through the external metal tube (1) in the subset of FIG. 16 (1 and 2) and subsequent assembly of the sealing gasket of MgO (3);

FIG. 17—refers to the view of the final assembly of the external metal tube that compacts the insulating mineral MgO (1) in the inner metal rod (2);

FIG. 18—refers to the conformation view of the inner metal rod (2);

FIG. 19—refers to the assembly view of the main metal body (2) in the subset of FIG. 20 (1 and 2);

FIG. 20—refers to the tridimensional view of the heating element designed to work as fuse effect;

FIG. 21—refers to the tridimensional view of the final assembly of the external metal tube (1) in the inner metal rod (1);

FIG. 22—refers to the tridimensional view of the assembly of the inner metal rod (1) in the heating element designed to work as fuse effect (2);

FIG. 23—refers to the tridimensional view of the compacted insulating mineral (2) inside the subset of FIG. 23 (1 and 2);

FIG. 24—refers to the tridimensional view of the assembly of the subset of FIG. 24 (1 and 2) in the external metal tube (3);

FIG. 25—refers to the tridimensional view of the subset of the inner metal rod (1), of MgO sealing gasket (2) and of the external metal tube (3);

FIG. 26—refers to the tridimensional view of the set of the sealing gasket (1) in the subset of FIG. 23 (1 and 2);

FIG. 27—refers to the tridimensional view of the heating set after the assembling process;

FIG. 28—refers to the tridimensional view of the assembly of the insulating ceramic gasket (1) in the subset containing the inner metal rod (2), the main metal body (3) and the external metal tube (4);

FIG. 29—refers to the tridimensional view of the assembly of the terminals subset (1) in the subset containing the inner metal rod (2)+ the insulating ceramic gasket (3)+ the main metal body (4)+ the external metal tube (5);

FIG. 30—refers to the work chart of the heating set, representing: the electric power curve of the heater in operation (1), the electric current curve of the heater in operation (2) and the electric voltage curve of the heater in operation (3).

### DETAILED DESCRIPTION OF THE PREFERRED EMBODIMENTS

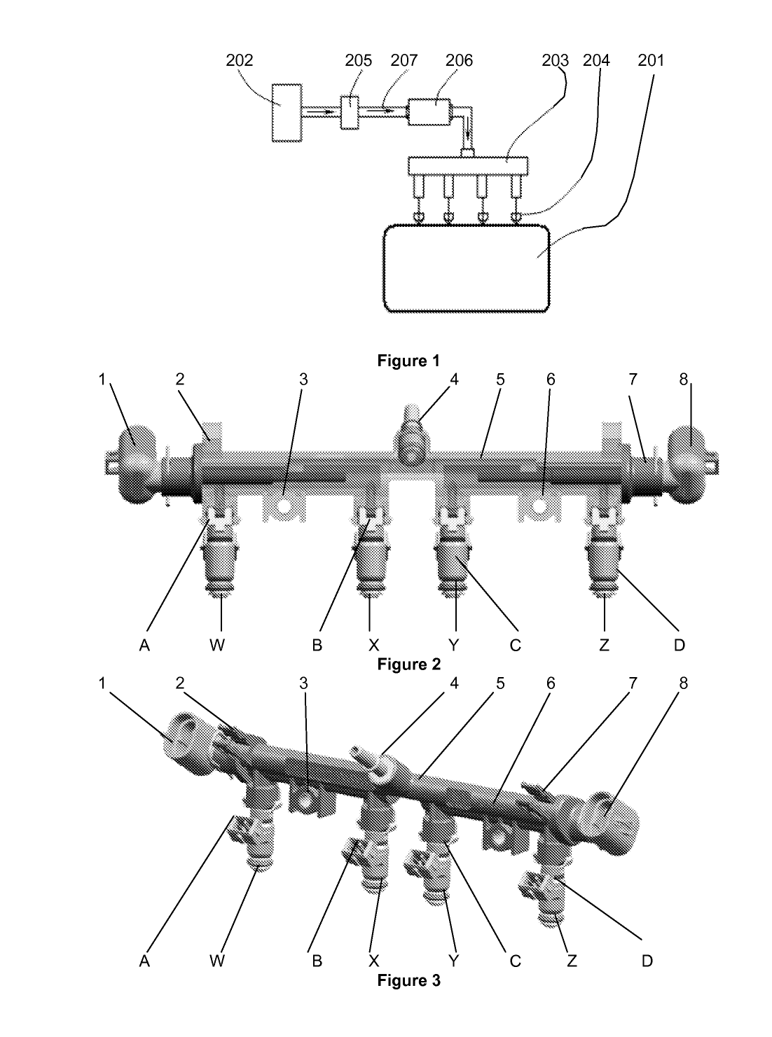

The present application will be exemplified for a conventional gasoline feeding system for cold ignition, schematically represented by FIG. 1, showing the reservoir (202), the supply pump with adequate fuel flow (205), feeding pipes (207) to a fuel dosing valve (206), a mini rail (203) required to supply dosed fuel to the pipes of the intake manifold, calibrated inserts (204) and engine intake manifold (201). This example is non limitative and is disclosed for a four cylinder engine, and it may be adapted to vehicles with more or fewer cylinders, as required.

FIG. 2 presents a tridimensional cross section view of the fuel rail set (203), representing the left fuel heater with fuse effect (1), object of the present invention, the lock spring (2) to hold the left fuel heater with fuse effect (1), the right holding bush of the rail set in the vehicle intake manifold (3), the fuel inlet tube (4), the plastic rail (5), the left holding bush of the rail set in the vehicle intake manifold (6), the lock spring (7) to hold the right fuel heater with fuse effect (8), the lock springs (A, B, C, D) to hold the fuel injectors sets (W, X, Y, Z). Such set, including all these elements, is registered under Magneti Marelli code CT.0104164.A.

FIG. 3 refers to the tridimensional view of the same rail set Magneti Marelli code CT.0104164.A, wherein we can see fuel heaters with fuse effect (1,8), lock springs (2, 7) to hold the heaters (1, 8), fuel inlet tube (4), plastic rail (5), left holding bush for the rail set in the vehicle intake manifold (6) and lock springs (A, B, C, D) to hold the fuel injectors sets (W, X, Y, Z).

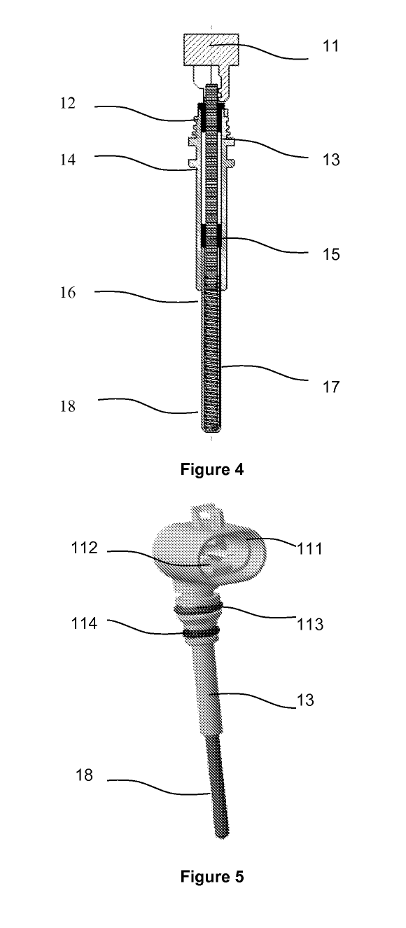

To better detail the invention, FIG. 4 shows a cross section view of the fuel heater set (1, 8) with fuse effect that transforms electric energy into thermal energy (Joule effect) with high performance and also to protect the system under critical operation conditions. The following are represented:

set of terminals (11) which receives electric energy incoming from the battery and controlled by the electronic control unit by a power module with switching function;

insulating ceramic gasket (12) which insulates the terminal electric contacts and it is made of said material or similar, to support the temperature of the terminal welding process in the inner rod (14);

main metal body (13) which protects the inner metal rod (14) and provides support to the whole set, it is manufactured in stainless material or any other material with similar properties to resist the corrosive action of the fluid fuel;

inner metal rod (14) which conducts the electric current from the terminals to the heating element (17) in spiral shape;

sealing gasket (15) of the insulator, preferably a mineral and, more preferably, MgO, which guarantees that there is no leakage or deterioration of said insulating mineral (MgO) from inside the heating capsule to the main metal body (13);

electric insulator (16), preferably a mineral and more preferably MgO, which insulates electrically the heating element (17) in spiral shape, which can be manufactured in magnesium oxide (MgO) or any other material with similar properties;

heating element (17) designed to work as fuse effect by means of the alloy or geometry to transform electric energy into thermal energy (Joule effect) with high performance and also to protect the system under critical control conditions;

external metal tube (18) which compacts the insulator and also transmits to the fuel, by direct contact, the heat received from the heating element in spiral shape (17), which is made in stainless material or any other material with similar properties to resist the fluid fuel.

The tridimensional view of the fuel heating set with fuse effect (1,8) represented by FIG. 5 shows the over injected connector (111) which provides support to the set of terminals (112) and allows appropriate assembly of the plastic rail (3) as shown by FIGS. 2 and 3. The larger sealing ring (113) which guarantees leakproofness of the assembly of the heater set (1, 8) and the smaller sealing ring (114), also to guarantee no leakage of the assembly of the heater set as per FIG. 29 at the rail set as per FIG. 3, performing a double safety feature, are also shown. We can also see from the outside the main metal body (13) and the external metal tube (18) which has direct contact with the fuel.

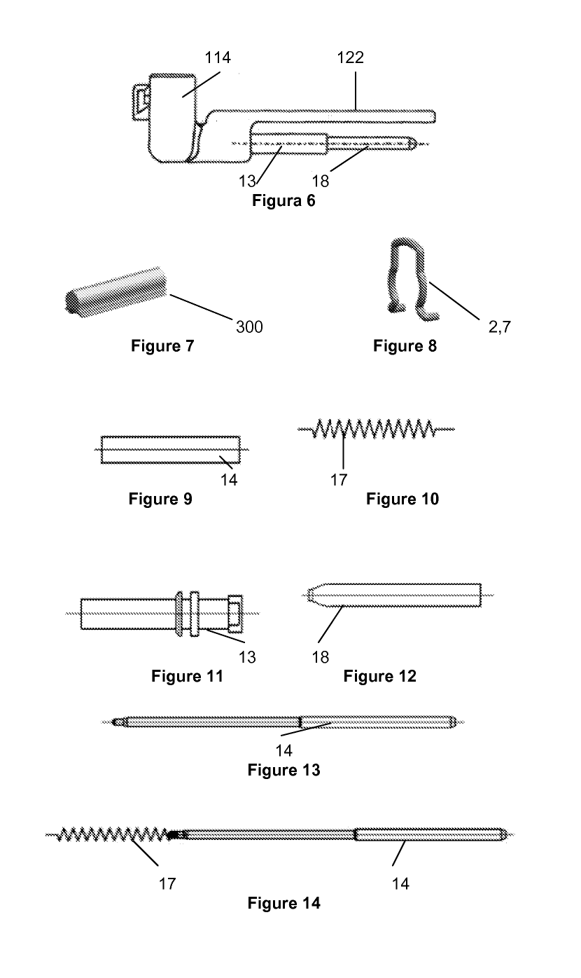

In an alternative configuration, the heating assembly (1, 8) can use a direct welding solution in the fuel rail. In this case, the rings (113, 114), the clamps (2, 7) of FIG. 8 and the volume reducer (300) of the fuel rail of FIG. 7 can be eliminated. As shown in FIG. 6, said solution intends that the over injected connector (111) have a main plastic body (122), able to be directly welded to the rail (3), the main metal body (113) and the external metal tube (114) that transmits heat to the fluid fuel.

The set of FIGS. 9 to 19 shows in cross sections the various parts of the fuel heating set with fuse effect (1, 8) and can be described as follows:

FIG. 9—refers to the view of the external metal tube (18) that compacts the insulating mineral MgO in its primitive manufacture stage;

FIG. 10—shows the heating element (17) designed to work as fuse effect and guarantee the integrity of the system;

FIG. 11 shows the main metal body (13) of the heater set (1, 8);

FIG. 12 shows the external metal tube (18) that compacts the insulating mineral after the first manufacturing/shaping process;

FIG. 13 shows the metal rod that transmits the electric current to the heating element (14);

FIG. 14 shows the assembly of the heating element designed to work as fuse effect (1) in the metal rod (14) that transmits the electric current (2);

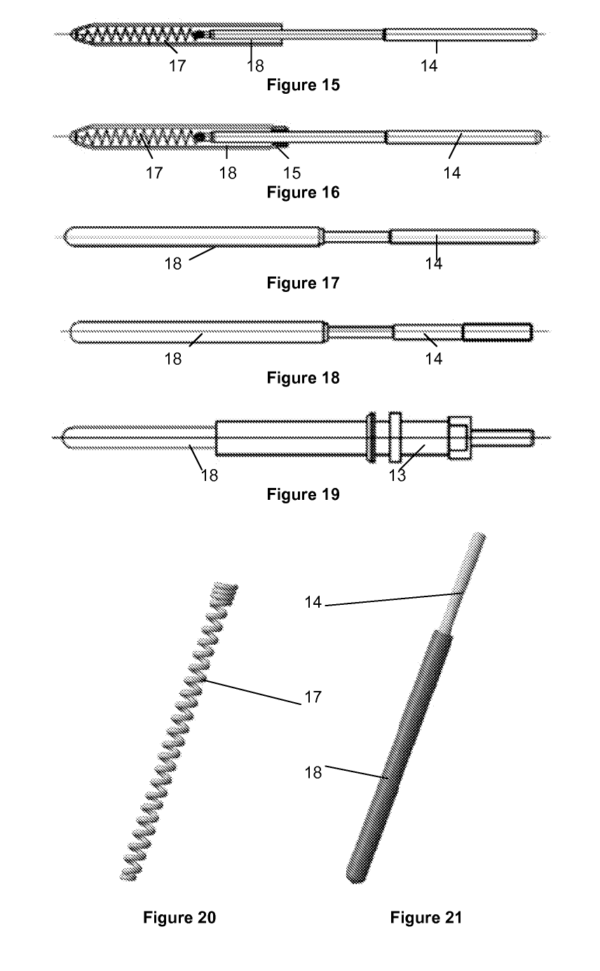

FIG. 15 shows the cross section view assembly of the external metal tube (18) that compacts the insulating mineral (MgO) in the subset of FIG. 14;

FIG. 16 shows the insulating mineral (16) through the external metal tube (18) in the subset of FIG. 14 (1 and 2) and subsequent assembly of the sealing gasket of MgO (15);

FIG. 17 shows the external view of the final assembly of the external metal tube (18) in the inner metal rod (14);

FIG. 18 shows the external view of the shaping assembly of the inner metal rod (14);

FIG. 19 shows the external view of the assembly of the main metal body (13) in the subset of FIG. 18.

FIGS. 20 to 29 show in tridimensional views, some of which exploded, the several parts of the fuel heater set with fuse effect (1, 8) and can be described as follows:

FIG. 20 shows the tridimensional view of the heating element (17) designed to work as fuse effect;

FIG. 21 shows the tridimensional view of the final assembly of the external metal tube (18) that compacts the insulating mineral (MgO) (16) in the inner metal rod (14);

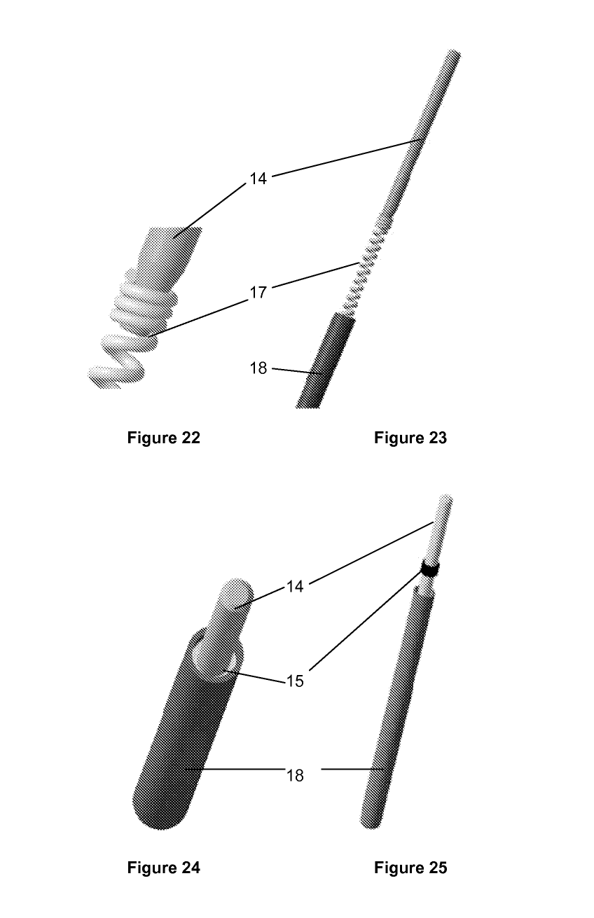

FIG. 22 shows the tridimensional view of the assembly of the inner metal rod (14) in the heating element designed to work as fuse effect (17);

FIG. 23 shows the tridimensional view of compacted insulating mineral (16) inside the subset of FIG. 21;

FIG. 24 shows the tridimensional view of the assembly of the subset of FIG. 22 in the external metal tube (18);

FIG. 25 shows the tridimensional view of the subset of the inner metal rod (14), the sealing gasket (15) for the electric insulator (MgO) (16) and the external metal tube (18);

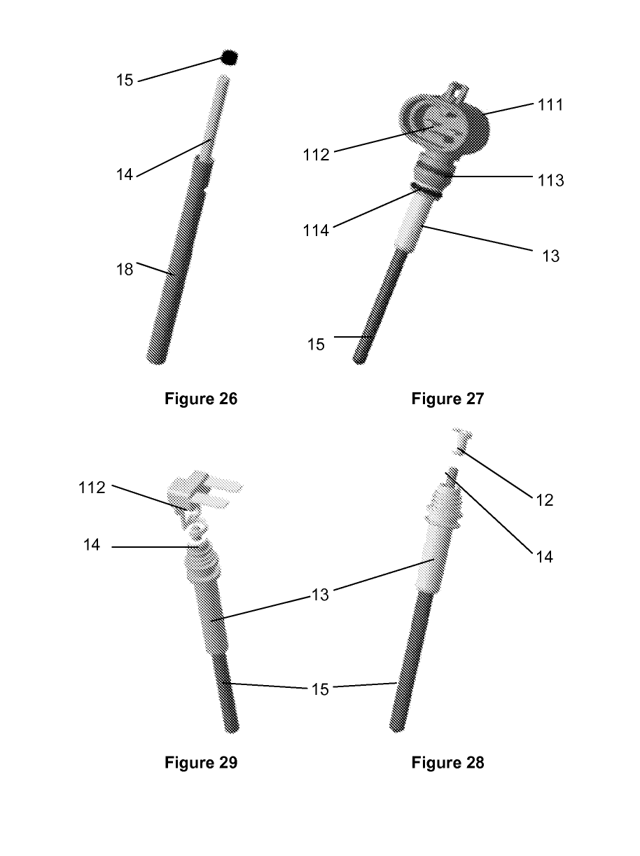

FIG. 26 shows the tridimensional view of the assembly of the sealing gasket (12) in the subset of FIG. 21;

FIG. 27 shows the tridimensional view of the heater set after the assembling process, showing: over injected connector (111), the set of terminals (112), the larger sealing ring (113), the smaller sealing ring (114), the main metal body (13) and the external metal tube (15) that compacts the electric insulator (MgO) (16);

FIG. 28 shows the tridimensional view of the insulating ceramic gasket set (12) in the subset containing the inner metal rod (14) of the main metal body (13) and the external metal tube (15) that compacts the electric insulator (MgO) (16);

FIG. 29 shows the tridimensional view of the assembly of the terminal subset (112) in the subset containing the inner metal rod (14), the insulating ceramic gasket (12), the main metal body (13) and the external metal tube (15) that compacts the electric insulator (MgO).

The heating device is designed to have a characteristic curve of premature degradation in case of any failure in the control system, involving both the electronic control unit and the ignition power module used for switching. The device at issue dissipates an electric power P consuming electric energy I when submitted to an electric voltage E. Variations of the physical quantities mentioned may occur due to changes in application, i.e., in the volume or geometry of the fuel rail and/or tolerances in manufacturing/industrialization processes.

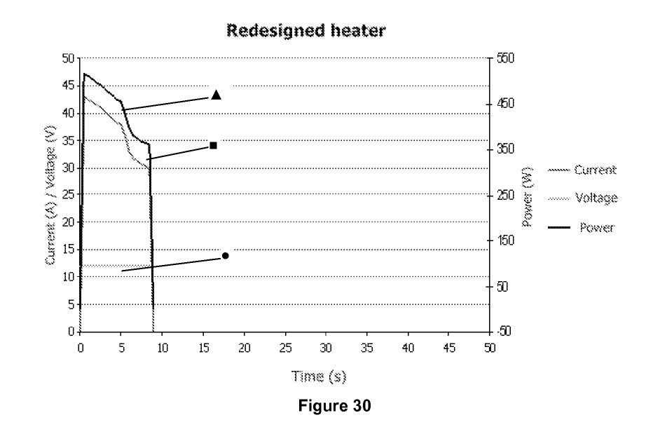

To better show the rate of efficiency of the solution disclosed by the present invention, tests have been made showing the operation of the heater set (1,7), according to the chart in FIG. 30, which shows the electric power curve of the heater in operation (▴), the electric current curve of the heater in operation (▪) and the electric voltage curve of the heater in operation ().

The main benefits of the present invention are clear as described previously and include:

the safety feature (fuse effect) required to guarantee the integrity of the system in case of a possible control failure of the electronic control unit (ECU);

it allows its installation in rails made of polymeric materials;

its construction is relatively simple and inexpensive.

What is claimed is:

1. Fuel heating set with fuse effect for cold ignition systems in vehicles provided with a reservoir (202), fuel supply pump (205), feeding pipes (207) to fuel dosage valve (206), mini rail (203) for fuel distribution to intake manifold ducts, calibrated inserts (204) and engine intake manifold (201), the heating set comprises:
a set of terminals (11) to receive electric energy from a battery and controlled by an electronic control unit by a power module with switching function, wherein said connectors are housed in an over injected connector (111) with terminals (112);
a heating element (17) designed to work as fuse effect;
an inner metal rod (14) to conduct electric current from the terminals (11) to the heating element (17), the heating element having a spiral shape;
an insulating gasket (12) of the inner metal rod (14);
a main metal body (13) that protects the inner metal rod (14);
an electric insulator (16);
a sealing gasket (15) of the electric insulating material (16); and
an external metal tube (18) to compact the insulator (16).

2. The heater set, according to claim 1, wherein the heater set (1, 8) comprises a first sealing ring (113) and a second sealing ring (114) smaller than the first sealing ring (113) to guarantee leakproofness and assembly of the heater set (1, 8).

3. The heater set, according to claim 1, wherein the heater set (1, 8) comprises the over injected connector (111) with a main plastic body (122), liable to be directly welded to the rail (3), the main metal body (113) and the external metal tube (18) that transmits heat to the fluid fuel.

4. The heater set, according to claim 1, wherein the electric insulator (16) is a mineral.

5. The heater set, according to claim 1, wherein the electric insulator (16) is magnesium oxide (MgO).

6. The heater set, according to claim 1, wherein the insulating gasket (12) of the inner metal rod (14) is a ceramic material.

7. The heater set, according to claim 1, wherein the electric connection terminals (112) comprise positive and negative poles, allowing their installation in rails of polymeric material or similar.

8. The heater set, according to claim 1, wherein the set (1, 8) being positioned axially inside the rail and at one or both of its ends.

9. The heater set, according to claim 1, wherein the set (1, 8) is activated by the electronic control unit by a nominal electric voltage E with current consumption I and power dissipation P.
